(19) United States
(12) Patent Application Publication
(10) Pub. No.: US 2026/0320348 A1
(43) Pub. Date: Oct. 15, 2026

(54) SYSTEM AND METHOD FOR CONTROLLING RESOURCE DEPLOYMENT USING RECURRENT NEURAL NETWORKS AND TOKENIZATION

(71) Applicant: BANK OF AMERICA CORPORATION, Charlotte, NC (US)

(72) Inventors: Agamya Mishra, Gurugram (IN); Radha Janakiraman, Chennai (IN); Saurabh Gupta, Dwarka (IN); Sandeep Kumar Chauhan, Miyapur (IN)

(73) Assignee: BANK OF AMERICA CORPORATION, Charlotte, NC (US)

(21) Appl. No.: 19/174,784

(22) Filed: Apr. 9, 2025

(51) Int. Cl. G06N 3/044; G06N 3/082

(52) U.S. Cl. CPC G06N 3/044; G06N 3/082

(57) ABSTRACT

Systems, computer program products, and methods are described herein for an optimal data carrier recommendation using a recurrent neural network (RNN) and tokenization. The present disclosure is configured to receive a data transmission request from a data transmission processing interface; identify user information and data carriers; identify and cause neurons to be activated in an RNN-based model; determine an optimal data carrier using the RNN-based model, wherein the RNN-based model is configured to (i) compute a sum of weighted values of the activated neurons for each of the identified data carriers based on the activated neurons and corresponding weights assigned to each of the activated neurons for each identified data carrier and (ii) select a data carrier associated with the highest sum of weighted values as the optimal data carrier; transfer data identifying the optimal data carrier to the user, wherein the weights are stored as non-fungible tokens (NFTs).

### TECHNOLOGICAL FIELD

Example embodiments of the present disclosure relate to an optimal data carrier recommendation system using recurrent neural network (RNN) and non-fungible token (NFTs).

### BACKGROUND

In modern environments, individuals frequently utilize data carriers to perform data transmissions in connection with accessing services. Many individuals possess multiple data carriers, each potentially offering distinct advantages related to data transmission efficiency, contextual priority, or access to supplementary services. However, individuals may be limited in awareness or access to comparative insights necessary to determine which data carrier is most optimally suited for a particular data transmission. Consequently, suboptimal selections may occur, resulting in reduced effectiveness or missing out on more advantageous outcomes for the data transmission.

### BRIEF SUMMARY

Systems, methods, and computer program products are provided for an optimal data carrier recommendation system.

In one aspect, a system for optimal data carrier recommendation is provided. In some embodiments, a system for an optimal data carrier recommendation using a recurrent neural network (RNN) and tokenization, the system comprising: a network interface configured to communicate via a communication network; a non-transitory memory device comprising computer-readable program code stored thereon; and at least one processing device operatively coupled to the network interface and the non-transitory memory device, wherein the computer-readable program code comprises computer instructions configured to, when executed by the at least one processing device, cause the at least one processing device to: receive, using the network interface and via the communication network, a data transmission request from a data transmission processing interface via a data exchange gateway, wherein the data transmission request is initiated by a user using the data transmission processing interface, wherein the data transmission request comprises data transmission information, and wherein the data exchange gateway facilitates communication with the data transmission processing interface; identify user information based on the data transmission information; identify, based on user record information associated with the identified user information, data carriers associated with the identified user information; identify, based on the identified data carriers and the data transmission information, neurons to be activated in an RNN-based model; cause the identified neurons to be activated in an RNN-based model; determine, from the identified data carriers, an optimal data carrier using the RNN-based model, wherein the RNN-based model is configured to (i) compute a sum of weighted values of the activated neurons for each of the identified data carriers based on the activated neurons and corresponding weights assigned to each of the activated neurons for each identified data carrier and (ii) select a data carrier associated with the highest sum of weighted values as the optimal data carrier, and wherein the weights are dynamically updated through training of the RNN-based model; transfer, using the network interface and via the communication network, data identifying the optimal data carrier to the data transmission processing interface via the data exchange gateway for the optimal data carrier recommendation to the user; receive, after transferring the data identifying the optimal data carrier, using the network interface and via the communication network, a data transmission result associated with the data transmission request from the data exchange gateway, wherein the data transmission result comprises a user-selected data carrier and process information associated with the data transmission request; and train, based on the user-selected data carrier and the process information, the RNN-based model to update the weights, wherein the updated weights are stored as non-fungible tokens (NFTs) for use by the RNN-based model for future data transmission requests.

In another embodiments, the RNN-based model is further configured to: determine, for each activated neuron of the activated neurons, a corresponding priority of the activated neuron; compute the sum of the weighted values of the activated neurons for each of the identified data carriers based on at least one activated neuron with higher priority to determine the optimal data carrier; and iteratively compute the sum of the weighted values by adding at least one activated neuron with a next higher priority until only one optimal data carrier with the highest sum of weighted values is determined in an instance where multiple data carriers with identical highest sums are determined.

In some embodiments, the non-transitory memory device comprises computer-readable program code that, when executed by the at least one processing device, causes the at least one processing device to, when training the RNN-based model, update corresponding priorities of the activated neurons in response to changes in the corresponding weights.

In some embodiments, the non-transitory memory device comprises computer-readable program code that, when executed by the at least one processing device, causes the at least one processing device to: receive, using the network interface via the communication network, and before receiving the data transmission request, an authorization from the user to execute an optimal data carrier recommendation process with the user record information using the user information; and execute the optimal data carrier recommendation process in response to receiving the data transmission request only in response to receiving the authorization.

In some embodiments, the data transmission processing interface is displayed via a point-of sale device.

In another embodiments, the user record information comprises, for each of a plurality of users, user information identifying one or more data carriers for the user and entitlement information associated with the one or more data carriers.

In some embodiments, the non-transitory memory device comprises computer-readable program code that, when executed by the at least one processing device, causes the at least one processing device to convert the sum of weighted values of the activated neurons for each of the identified data carriers into a probability.

In certain embodiments, a first neuron of the identified neurons is identified based on geo-location information of the data transmission processing interface within the data transmission information of the data transmission request, and wherein first weighted values associated with geo-location information assigned to each of the activated neurons for each identified data carrier are updated to reflect network stability condition of a geo-location for data transmission of the data transmission request.

In some embodiments, the updated weights stored as NFTs are used by a first RNN-based model for a first data transmission request from a first user.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made to the accompanying drawings. The components illustrated in the figures may or may not be present in certain embodiments described herein. Some embodiments may include fewer (or more) components than those shown in the figures.

FIG. 1 illustrates technical components of an exemplary distributed computing environment for an optimal data carrier recommendation system, in accordance with an embodiment of the disclosure.

FIG. 2 illustrates an exemplary machine learning (ML) subsystem architecture, in accordance with an embodiment of the disclosure.

FIG. 3 illustrates an exemplary process of creating an NFT, in accordance with an embodiment of the disclosure.

FIG. 4 illustrates a process flow for an optimal data carrier recommendation system, in accordance with an embodiment of the disclosure.

FIG. 5 illustrates an exemplary architecture of an optimal data carrier recommendation system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be a client of the entity or enterprises affiliated with the entity.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “data” or “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, data may be associated with one or more accounts or may be property that is not associated with a specific account. Examples of data associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, data is typically stored in a data repository-a storage location where one or more data are organized, stored and retrieved electronically using a computing device.

As used herein, a “data transmission,” “data distribution,” or “data allocation” may refer to any transaction, activities or communication between one or more entities, or between the user and the one or more entities. A data transfer may refer to any distribution of data such as, but not limited to, a payment, processing of funds, purchase of goods or services, a return of goods or services, a payment transaction, a credit transaction, or other interactions involving a user's data or account. Unless specifically limited by the context, a “data transmission” a “transaction”, “transaction event” or “point of transaction event” may refer to any activity between a user, a merchant, an entity, or any combination thereof. In some embodiments, a data transmission or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that data transmission or transactions are evaluated, it could mean that the transaction has already occurred, is in the process of occurring or being processed, or that the transaction has yet to be processed/posted by one or more financial institutions. In some embodiments, data transmission or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, a “data carrier” refers to any electronic or digital mechanism configured to facilitate a data transmission. The data carrier may comprise a physical or virtual payment vehicle, such as an electronic credit card, debit card, prepaid card, or other card-linked payment method. The data carrier may alternatively be implemented as account-identifying information stored electronically in a user device, including but not limited to encrypted payment credentials, tokenized representations of payment details, or aliases associated with a digital wallet. The data carrier may be stored, managed, or processed through a payment gateway, merchant token vault, secure transaction network, or other financial infrastructure.

As used herein, an “entitlement information” refers to structured attributes that describe the conditions, preferences, or usage advantages associated with the application of the data carrier within a given data transmission request. Such information may comprise carrier-specific characteristics, such as eligibility for enhanced processing capabilities (e.g., priority handling, premium access), contextual prioritization (e.g., promotions or reward under condition), access to supplementary services (e.g., bonus points, rewards), usage efficiency parameters (e.g., discounts, assessment waivers), or other preferential treatment (e.g., institution-specific offers or benefits) defined by the issuing entity. In certain embodiments, entitlement information may be statically assigned or dynamically adjusted based on one or more contextual variables, such as the type of data transmission, a service category code, and/or similar classification parameters. Such contextual variables may influence the carrier-specific characteristics in accordance with the associated structured attributes.

As used herein a “data exchange gateway” refers to a “payment gateway”. The data exchange gateway is a computing system or networked infrastructure that facilitates the processing, authentication, and transmission of transaction data between a merchant system, a payment processor, and one or more financial institutions. In some embodiments, the data exchange gateway serves as an intermediary that securely transmits payment details from a point-of-sale (POS) system, an online checkout interface, or a mobile payment application to a financial network for authorization. The data exchange gateway may support various payment methods, including credit cards, debit cards, digital wallets, electronic fund transfers, and tokenized payment instruments. The data exchange gateway may be operatively connected to acquiring financial institutes, issuing financial institutes, payment processors, unauthorized activity or deception detection systems, and merchant databases, enabling it to validate transaction details, authenticate users, and apply security protocols such as encryption, tokenization, and multi-factor authentication to prevent unauthorized access and mitigate security vulnerability. In certain embodiments, the data exchange gateway may facilitate real-time transaction processing, batch settlement of transactions, and integration with merchant payment systems for financial reconciliation.

As used herein, an “engine” may refer to core elements of an application, or part of an application that serves as a foundation for a larger piece of software and drives the functionality of the software. In some embodiments, an engine may be self-contained, but externally controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, a “module” refers to a functional component or unit configured to perform one or more specified tasks. The module may be implemented in hardware, software, firmware, or any combination thereof. In some embodiments, the module may include one or more processors, memory elements, or computer-readable instructions that, when executed, cause the module to perform the described functionality. The module can operate independently or in conjunction with other modules within the system, communicating via predefined interfaces, communication protocols, or data exchange mechanisms. Modules may be arranged in a distributed or centralized architecture and may be dynamically reconfigurable or adaptive to changing conditions or inputs.

As used herein, an “Application Programming Interface (API)” is a defined set of protocols, specifications, and interaction mechanisms that enable a software system, component, or software module to expose its functionalities, operations, and/or data to other computing entities. The API serves as an abstraction layer, allowing external or internal systems to access the underlying functional operations or processing logic, data stores, or computation workflows without requiring direct integration with the source code or execution environment. The APIs are typically implemented using standard communication protocols, such as hypertext transfer protocol (HTTP), hypertext transfer protocol secure (HTTPS), WebSocket protocol, and/or the like, and may follow architectural styles, such as representational state transfer (REST), graph query language (GraphQL), or simple object access protocol (SOAP), and/or the like. The API interface includes defined endpoints, methods, authentication mechanisms, and data formats to ensure consistent and secure interaction.

In various implementations, the system may employ an API Plugin, which refers to a modular, configurable software component designed to facilitate interaction with one or more APIs. The API Plugin abstracts the invocation logic required to construct, dispatch, and manage API calls, including endpoint configuration, authentication handling, parameter transformation, payload formatting, and response parsing. The API Plugin enables dynamic or runtime selection of different API providers or endpoints. Additionally, the API Plugin may serve as a routing or orchestration layer that mediates between the core system and external services. When a system initiates an API call through the plugin, the plugin constructs a compliant request message, transmits it to the appropriate API endpoint, receives the response, and optionally reformats or normalizes the data for downstream processing.

Users frequently utilize data carriers to execute data transmissions in connection with accessing services. A user may possess multiple data carriers, each of which may comprise entitlement information offering distinct advantages related to data transmission efficiency, contextual priority, or access to supplementary services. However, users may be unaware of, or lack access to, comparative information necessary to identify the data carrier best suited for a given data transmission. As a result, users may select a suboptimal data carrier, potentially missing out on more advantageous outcomes for the data transmission.

In order to utilize an optimal data carrier for a data transmission, a user may receive a recommendation from an optimal data carrier recommendation system configured to determine a data carrier that maximizes the overall advantages offered to the user among the available data carriers the user possesses. The system may be configured to receive a data transmission request initiated by the user and to identify available data carriers associated with the user. The system is further configured to identify parameters for recommending the optimal data carrier and to execute a recurrent neural network (RNN)-based computation to determine the optimal data carrier for the data transmission. One key parameter is a weight value assigned to neurons used in the RNN-based computation for each of the available data carriers. These weight values may be stored in non-fungible tokens (NFTs) to ensure immutability and secure access control. The system may be further configured to train or update the parameters associated with the data transmission process to reflect the latest changes affecting those parameters.

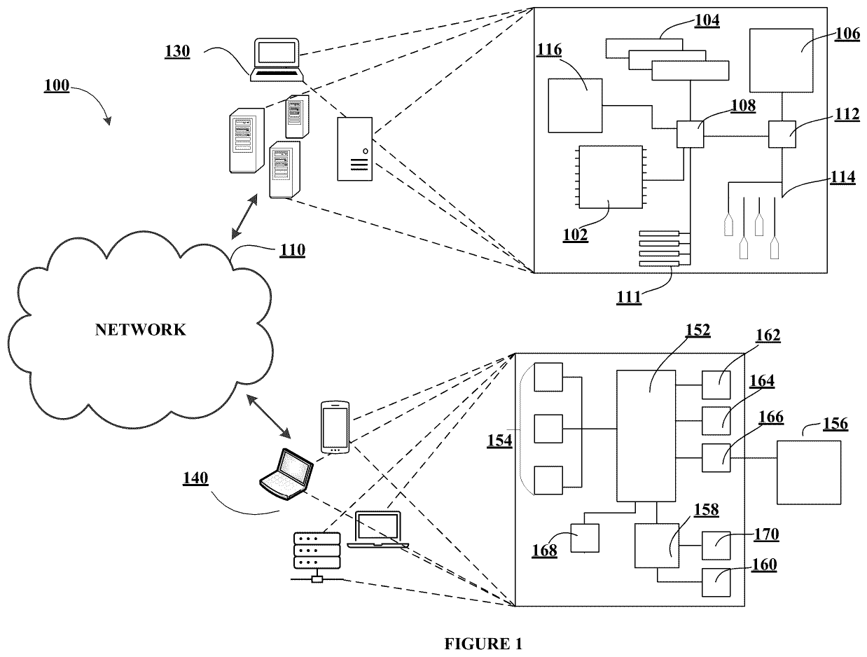

FIG. 1 illustrate technical components of an exemplary distributed computing environment 100 for an optimal data carrier recommendation system, in accordance with an embodiment of the disclosure. As shown in FIG. 1, the distributed computing environment 100 contemplated herein may include a system 130, an end-point device(s) 140, and a network 110 over which the system 130 and end-point device(s) 140 communicate therebetween. FIG. 1 illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

The system 130 may include a processor 102, memory 104, input/output (I/O) device 116, and a storage device 106. The system 130 may also include a high-speed interface 108 connecting to the memory 104, and a low-speed interface 112 connecting to low speed bus 114 and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other. In some embodiments, the optimal data carrier recommendation system is configured to use one or more components, or a combination of components, of the system 130 to perform an optimal data carrier recommendation process.

The end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

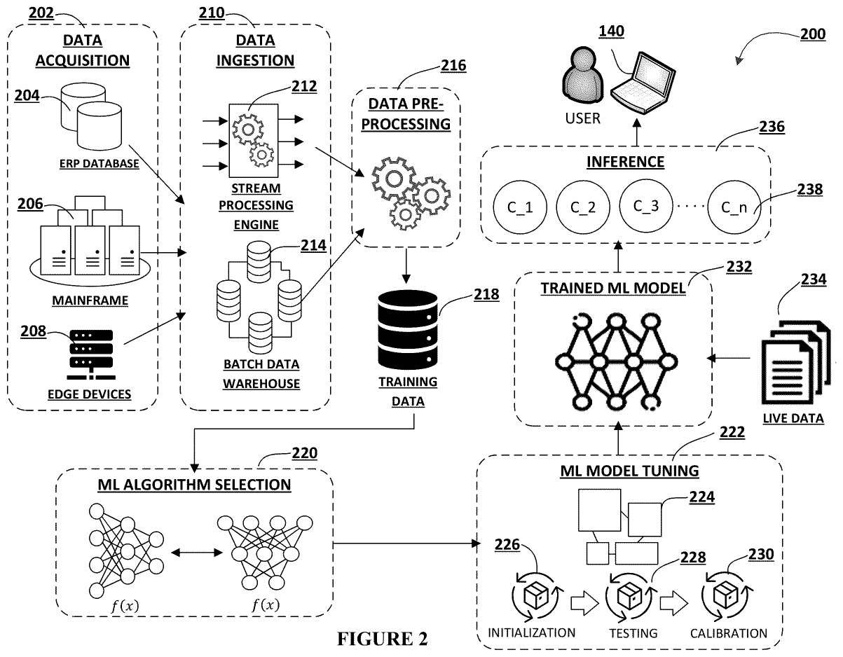

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Recurrent Neural Network (RNN) method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like. In some embodiments, Recurrent Neural Networks (RNNs) may be used for modeling and predicting time-dependent or sequential data, such as user activity sequences, sensor signal trends, or notification histories. Additionally, RNNs may be leveraged to recommend optimal data carrier for a user with various inputs associated with a data transmission or transaction.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

In some embodiments, the optimal data carrier recommendation system is configured to utilize a portion or a combination of portions of the machine learning subsystem 200 to execute one or more machine learning processes (e.g., RNN) or algorithms within the system to perform the optimal data carrier recommendation process.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

An NFT is a cryptographic record (referred to as “tokens”) linked to a resource. An NFT is typically stored on a distributed ledger that certifies ownership and authenticity of the resource, and exchangeable in a peer-to-peer network.

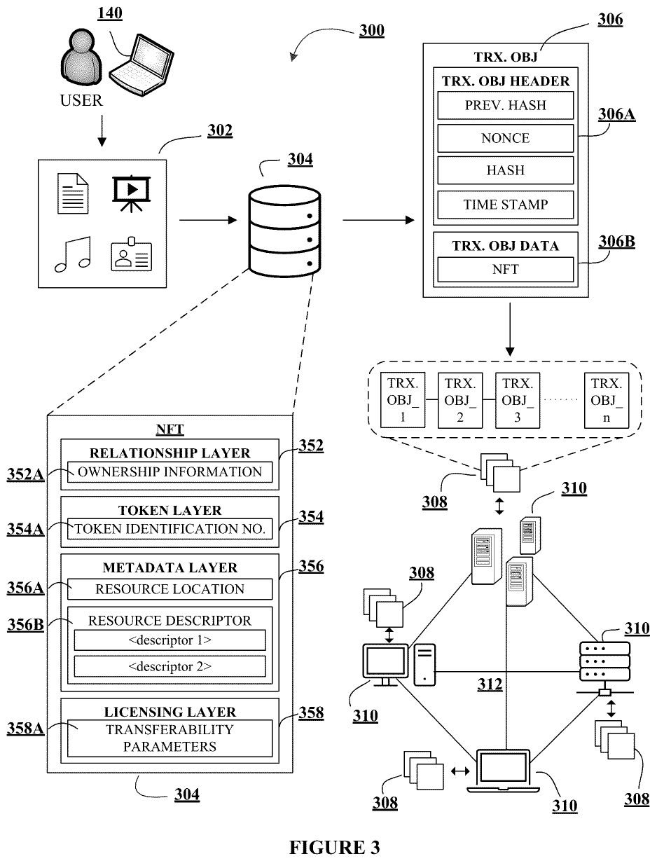

FIG. 3 illustrates an exemplary process of creating an NFT 300, in accordance with an embodiment of the invention. As shown in FIG. 3, to create or “mint” an NFT, a user (e.g., NFT owner) may identify, using a user input device 140, resources 302 that the user wishes to mint as an NFT. Typically, NFTs are minted from digital objects that represent both tangible and intangible objects. These resources 302 may include a piece of art, music, collectible, virtual world items, videos, real-world items such as artwork and real estate, or any other presumed valuable object. These resources 302 are then digitized into a proper format to produce an NFT 304. The NFT 304 may be a multi-layered documentation that identifies the resources 302 but also evidences various transaction conditions associated therewith, as described in more detail with respect to FIG. 3.

To record the NFT in a distributed ledger, a transaction object 306 for the NFT 304 is created. The transaction object 306 may include a transaction header 306A and a transaction object data 306B. The transaction header 306A may include a cryptographic hash of the previous transaction object, a nonce—a randomly generated 32-bit whole number when the transaction object is created, cryptographic hash of the current transaction object wedded to the nonce, and a time stamp. The transaction object data 306B may include the NFT 304 being recorded. Once the transaction object 306 is generated, the NFT 204 is considered signed and forever tied to its nonce and hash. The transaction object 306 is then deployed in the distributed ledger 308. At this time, a distributed ledger address is generated for the transaction object 306, i.e., an indication of where it is located on the distributed ledger 308 and captured for recording purposes. Once deployed, the NFT 304 is linked permanently to its hash and the distributed ledger 308, and is considered recorded in the distributed ledger 308, thus concluding the minting process.

As shown in FIG. 3, the distributed ledger 308 may be maintained on multiple devices (nodes) 310 that are authorized to keep track of the distributed ledger 308. For example, these nodes 310 may be computing devices such as system 130 and end-point device(s) 140. One node 310 may have a complete or partial copy of the entire distributed ledger 308 or set of transactions and/or transaction objects on the distributed ledger 308. Transactions, such as the creation and recordation of a NFT, are initiated at a node and communicated to the various nodes with node networks 312. Any of the nodes can validate a transaction, record the transaction to its copy of the distributed ledger, and/or broadcast the transaction, its validation (in the form of a transaction object) and/or other data to other nodes.

Additionally, FIG. 3 illustrates an exemplary NFT 304 as a multi-layered documentation of a resource. As shown in FIG. 3, the NFT may include at least relationship layer 352, a token layer 354, a metadata layer 356, and a licensing layer 358. The relationship layer 352 may include ownership information 352A, including a map of various users that are associated with the resource and/or the NFT 304, and their relationship to one another. For example, if the NFT 304 is purchased by buyer B1 from a seller S1, the relationship between B1 and S1 as a buyer-seller is recorded in the relationship layer 352. In another example, if the NFT 304 is owned by O1 and the resource itself is stored in a storage facility by storage provider SP1, then the relationship between O1 and SP1 as owner-file storage provider is recorded in the relationship layer 352. The token layer 354 may include a token identification number 354A that is used to identify the NFT 304. The metadata layer 356 may include at least a file location 356A and a file descriptor 356B. The file location 356A may provide information associated with the specific location of the resource 302. Depending on the conditions listed in the smart contract underlying the distributed ledger 308, the resource 302 may be stored on-chain, i.e., directly on the distributed ledger 308 along with the NFT 304, or off-chain, i.e., in an external storage location. The file location 356A identifies where the resource 302 is stored. The file descriptor 356B may include specific information associated with the source itself 302. For example, the file descriptor 356B may include information about the supply, authenticity, lineage, provenance of the resource 302. The licensing layer 358 may include any transferability parameters 358B associated with the NFT 304, such as restrictions and licensing rules associated with purchase, sale, and any other types of transfer of the resource 302 and/or the NFT 304 from one person to another. Those skilled in the art will appreciate that various additional layers and combinations of layers can be configured as needed without departing from the scope and spirit of the invention.

In some embodiments, the optimal data carrier recommendation system is configured to utilize a portion or a combination of portions of the process of creating an NFT 300 to store parameters to execute the optimal data carrier recommendation process.

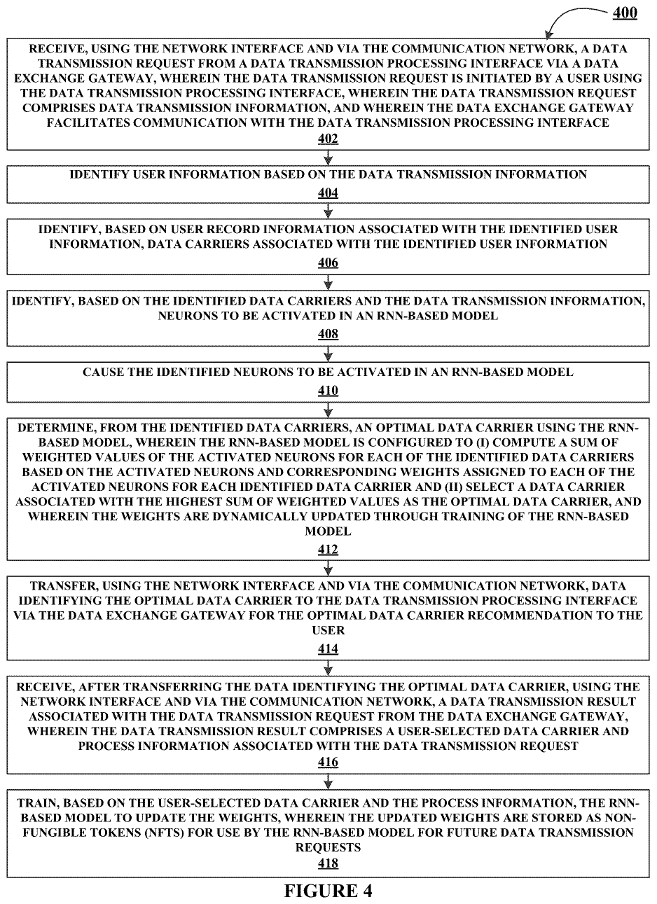

FIG. 4 illustrates a process flow 400 for the optimal data carrier recommendation process, in accordance with an embodiment of the disclosure. In some embodiments, the system may perform one or more of the steps of process flow 400. For example, a system (e.g., the system 130 described herein with respect to FIG. 1) may perform the steps of process 400.

As shown in block 402, the process flow 400 may include the step of receiving, using the network interface and via the communication network, a data transmission request from a data transmission processing interface via a data exchange gateway, wherein the data transmission request is initiated by a user using the data transmission processing interface, wherein the data transmission request comprises data transmission information, and wherein the data exchange gateway facilitates communication with the data transmission processing interface.

For example, and in some embodiments, the system may receive a request for data transmission initiated by the user from a data transmission processing interface through a data exchange gateway. The data transmission processing interface may be an end-point device 140, such as a POS system, online payment system, payment platform or application via a user device, peer-to-peer payment system and/or the like that transfers data transmission request to the data exchange gateway. The data exchange gateway may employ one or more security mechanisms, including but not limited to encryption, tokenization, transport layer security (TLS) and secure socket layer (SSL) communication, and suspicious activity detection protocols, to ensure confidentiality and integrity of transaction data.

The data transmission request is initiated by the user and may comprise data transmission information, such as amount of data transmission, exchange participant identifier (e.g., a vendor ID, terminal ID, or service category code), data carrier information that comprises user information (e.g., data carrier holder information), and/or any other information associated with processing the data transmission. The data transmission request may involve card transaction or non-card transaction depending on initial selection of the data carrier from the user.

As shown in block 404, the process flow 400 may include the step of identifying user information based on the data transmission information. For example, and in some embodiments, the system may be configured to identify the user with the data carrier information (e.g., data carrier holder information) extracted from the received data transmission request. In this way, the system may access and identify information to process the optimal data carrier recommendation process stored in a user record information.

In some embodiments, the user record information may comprise the user's enrollment status for receiving optimal data carrier recommendations from the system, as well as the user's authorization for the system to execute the optimal data carrier recommendation process. In certain embodiments, the system may be configured to execute the optimal data carrier recommendation process only upon identifying that the user is enrolled and has provided the necessary authorization to permit execution of the recommendation process.

As shown in block 406, the process flow 400 may include the step of identifying, based on user record information associated with the identified user information, data carriers associated with the identified user information. For example, and in some embodiments, the optimal data carrier recommendation system is configured to identify data carriers that is available to the user using the user record information based on the user information extracted from the data transmission request.

In some embodiments, the user record information may comprise information about one or more available data carriers for each enrolled and approved user that can be used to execute a data transmission request, and may further comprise entitlement information associated with the available data carriers. The available data carriers are issued by or associated with an institution that is backed by a government-authorized entity providing institutional safeguards or protections for allocated data.

In certain embodiments, entitlement information may be statically assigned or dynamically adjusted based on parameters, such as a type of data transmission, a service category code, and/or similar classification parameters. Such parameters may influence the carrier-specific characteristics (e.g., discount rates, reward points, promotions, and/or the like) in accordance with the entitlement information. The system may be configured to identify such parameters from the data transmission information included in the data transmission request.

In some embodiments, the user record information may be stored in a user record database, which includes information such as the user's enrollment status, the user's authorization to receive optimal data carrier recommendations, the user's available data carriers, and entitlement information associated with the available data carriers. Each data element may be updated upon the occurrence of a relevant change or may be periodically refreshed at predefined intervals. In certain embodiments, the user record information may be distributed across multiple databases, depending on the system architecture.

As shown in block 408, the process flow 400 may include the step of identifying, based on the identified data carriers and the data transmission information, neurons to be activated in an RNN-based model. For example, and in some embodiments, the optimal data carrier recommendation system may be configured to identify neurons to be activated in a recurrent neural network (RNN)-based model to utilize the RNN-based model to execute the optimal data carrier recommendation process.

The RNN-based model is a machine learning architecture that may be implemented as part of machine learning subsystem 200 and is configured to process sequential and/or context-dependent data. The RNN-based model comprises a plurality of interconnected computational nodes, referred to as neurons, arranged in one or more layers that include recurrent connections. These recurrent connections enable the propagation of information from prior processing steps to subsequent ones, thereby allowing the model to retain and utilize contextual information when evaluating available data carriers associated with a user.

In certain embodiments, the RNN-based model is configured to receive input data associated with the data transmission request, and sequentially process the input data to generate an output representing an optimal data carrier. The recurrent connections allow the model to retain temporal or contextual dependencies across inputs, enabling it to make informed decisions based on historical or sequential patterns.

As shown in block 410, the process flow 400 may include the step of causing the identified neurons to be activated in an RNN-based model. For example, the optimal data carrier recommendation system is configured to identify relevant input information from the available data carriers (e.g., entitlement information, network requirements for data transmission, user preferences, usage frequency, and/or the like) and the data transmission request (e.g., user information, geo-location, service category code, and/or the like) in order to determine which neurons are to be activated within the model.

For instance, and in some embodiments, the neurons may correspond to one or more contextual features, including but not limited to: an enrollment status, a geo-location of the data transmission processing interface, entitlement information associated with the available data carriers, past data transmission history associated with the user, a reduced data transmission assessment, user preferences, and/or similar variables. One or more neurons associated with the enrollment status may be activated when the system identifies, from the user record database, that the user is enrolled in the system to receive optimal data carrier recommendations. One or more neurons associated with the geo-location may be activated when the location of the data transmission processing interface is identified from the data transmission request or via the data exchange gateway. In this way, the model may be configured to identify a network stability or technical issues associated with each of the data carriers for the data transmission based on the identified geo-location for the data transmission. In another case, a neuron associated with a user preference of selecting the data carrier in certain geo-location may be activated. One or more neurons associated with the entitlement information and the reduced data transmission assessment may be activated for each of the identified data carriers available to the user, when such information is identified from the user record database. One or more neurons associated with the past data transmission history and the user preferences may be activated when corresponding information is identified from the past data transmission records.

As shown in block 412, the process flow 400 may include the step of determining, from the identified data carriers, an optimal data carrier using the RNN-based model, wherein the RNN-based model is configured to (i) compute a sum of weighted values of the activated neurons for each of the identified data carriers based on the activated neurons and corresponding weights assigned to each of the activated neurons for each identified data carrier and (ii) select a data carrier associated with the highest sum of weighted values as the optimal data carrier, and wherein the weights are dynamically updated through training of the RNN-based model.

For example, and in some embodiments, the RNN-based model may be utilized to evaluate the identified available data carriers associated with a user with the activated neurons corresponding to specific features of input information. Each activated neuron in the model applies a weightage to its initial value based on associated weight parameters, and the model computes one or more aggregate scores for each of the neuron to the available data carriers. The scores may be used to determine the optimal data carrier based on learned patterns within the model.

As used herein, weights refer to numerical parameters assigned to the connections between neurons and the available data carriers in the RNN-based model. Each weight represents the relative importance or influence of the activated neuron to the available data carriers. During the model's forward pass, weights are used to scale input values and intermediate outputs, thereby contributing to the final computed output of the network. In some embodiments, the weights are initially assigned random or predefined values and are subsequently adjusted during the training process based on one or more optimization algorithms (e.g., gradient descent). The training process updates the weights in a manner that minimizes the difference between the model's predicted output and the expected outcome, thereby allowing the model to learn complex patterns or relationships from input data over time.

In the context of the optimal data carrier recommendation system, weights may be assigned to the connections between data carriers and neurons representing various contextual features, such as user preferences, entitlement information, geo-location, and/or similar variables. For instance, the weights may be updated to reflect factors such as network stability or technical issue associated with a specific geo-location for each of the data carriers; a user's preference for selecting a particular data carrier within a given geo-location; distinctions in entitlement information across data carriers based on specific categories of the data transmission request; and/or the like. These weights may be continuously updated through training the RNN-based model to capture dynamic relationships between input data associated with a data transmission request and optimal data carrier selection outcomes. The combination of activated neurons and their associated weights may be used to compute an aggregate score for each available data carrier. The data carrier associated with the highest aggregate score may be selected as the optimal data carrier for a given data transmission request. In some embodiments, the updated weights may be shared for use in another optimal data carrier recommendation process session for other users, or by another system requiring updated weight values for its computations.

In some embodiments, the system may be configured to convert the aggregate score for each identified data carrier into probability values. The conversion may be performed using a normalization function, such as a softmax activation function or a similar probabilistic transformation technique. The softmax function operates by exponentiating each input score and dividing it by the sum of all exponentiated scores, thereby producing a probability distribution over the set of candidate data carriers. The resulting probabilities indicate the relative likelihood or confidence associated with each data carrier being the optimal selection for the given data transmission request.

As used herein, layers refer to structured groupings of neurons, that are arranged to perform sequential processing of input data. Each layer receives input from one or more preceding layers and produces output that may be passed to subsequent layers in the neural network. In some embodiments, the RNN-based model includes multiple layers configured to evaluate input features associated with available data carriers in a staged or iterative manner. In certain implementations, a first layer comprising a limited set of neurons may be activated to process high-priority or core contextual features (e.g., user enrollment status, entitlement information, or geo-location) to compute an initial score for each identified available data carrier. If the initial evaluation results in two or more data carriers sharing the highest score or falling within a predefined similarity threshold, the system may be configured to activate one or more subsequent layers, each comprising additional neurons associated with secondary or supporting contextual features (e.g., past transmission history, user preferences, real-time network parameters, and/or the like). Each successive layer refines the evaluation by incorporating additional feature data, with the process repeating iteratively until a single optimal data carrier is determined based on the output of the final active layer. Such a layered architecture enables the system to manage computational efficiently and improves recommendation precision.

In some embodiments, the system may be configured to dynamically determine the subset of neurons to be activated within the RNN-based model based on the contextual priority of features extracted from the data transmission request and associated data carriers. Although the underlying architecture may comprise a predefined number of neurons, the system may selectively activate only those neurons deemed relevant to the current inference context.

In alternative implementations, the system may be further configured to dynamically adjust the number of active neurons in one or more layers of the RNN-based model based on priority values assigned to the neurons. The system may be configured to assign and manage priority values associated with individual neurons within the RNN-based model. A neuron priority may refer to a numerical or categorical indicator representing the relative significance, influence, or relevance of a given neuron in the context of evaluating available data carriers for a data transmission request. The priority of a neuron may influence one or more of the following: (i) the activation threshold of the neuron, (ii) the weight assigned to the neuron's output during aggregate score computation, (iii) the order in which neurons are processed across layers, or (iv) whether the neuron is included in a given inference cycle. High-priority neurons may be activated more frequently or be assigned to early layer during the activation evaluation process, while low-priority neurons may be conditionally activated based on secondary activation requirements. The system may be further configured to train the priority values of the neurons based on a variety of factors. These factors may include, but are not limited to, the historical effectiveness of the neuron, which reflects whether activation of the neuron has previously resulted in the user's selection of the recommended optimal data carrier; the contextual relevance of the neuron's associated feature, indicating how strongly it correlates with successful outcomes under specific data transmission contexts, such as particular geo-locations, service categories, or user preference of selecting a data carrier; the activation frequency, representing how often the neuron is triggered during training sessions or real-time decision operations; the predictive contribution of the neuron, which may be measured as the neuron's statistical or learned impact on minimizing the model's prediction error, as determined through backpropagation or other optimization techniques; and significant updates in associated weights, which may reflect a substantial shift in input conditions or parameters, such as network instability or unexpected external events.

In some implementations, the system may update neuron priorities continuously during training using gradient-based learning techniques, reinforcement feedback from actual transmission outcomes, or by applying heuristic scoring models that evaluate neuron impact over time. This enables the RNN-based model to adaptively emphasize the most relevant features, improving both performance and computational efficiency in generating optimal data carrier recommendations.

As shown in block 414, the process flow 400 may include the step of transferring, using the network interface and via the communication network, data identifying the optimal data carrier to the data transmission processing interface via the data exchange gateway for the optimal data carrier recommendation to the user. For example, and in some embodiments, the system may be configured to transmit information identifying the determined optimal data carrier to the data transmission processing interface via a data exchange gateway, whereby the user can receive a recommendation of the optimal data carrier for the corresponding data transmission request.

In some embodiments, the system may be configured to transfer the results of the optimal data carrier determination to a user device via a platform or application. Additionally, the system may be further configured to transmit detailed information associated with the optimal data carrier recommendation process, including, but not limited to, probability values corresponding to each evaluated data carrier, applicable entitlement information related to the data transmission request, information identifying the next-optimal available data carrier, and/or the like.

As shown in block 416, the process flow 400 may include the step of receiving, after transferring the data identifying the optimal data carrier, using the network interface and via the communication network, a data transmission result associated with the data transmission request from the data exchange gateway, wherein the data transmission result comprises a user-selected data carrier and process information associated with the data transmission request. For example, the system may be configured to receive a data transmission result from the data exchange gateway, the data transmission result that comprises the actual data carrier selected by the user for the data transmission request, along with process-related information generated during the data transmission.

The data transmission result may comprise various records generated during the data transmission process, including, for example, the amount of data transmitted, transmission rejections and corresponding reasons, indicators of successful completion, any network-related issues, the results of entitlement information evaluation for the data carrier that was processed, and/or the like. The user-selected data carrier information refers to the actual data carrier selected and used by the user, which may differ or identical from the data carrier recommended by the system.

In some embodiments, the system may be further configured to prompt the user, via a platform or application on the user device, to provide feedback indicating why the recommended data carrier was not used. This feedback may then be utilized to train the RNN-based model and improve the accuracy of future recommendations. The past data transmission results associated with the user may comprise historical outcomes of previous data transmission requests, along with contextual and performance data, which can be analyzed to further refine the model's parameters over time.

In some embodiments, the optimal data carrier recommendation system may be configured to access one or more systems (e.g., the data exchange gateway, a data transmission system) or databases associated with the data transmission process in order to obtain the data transmission result corresponding to a given data transmission request. The retrieved data transmission result may then be utilized to perform backpropagation training of the RNN-based model. The trained RNN-based model may update the weights to reflect the most recent results, thereby enabling the RNN-based model to adaptively adjust model's parameters based on newly observed data or outcomes.

As shown in block 418, the process flow 400 may include the step of training, based on the user-selected data carrier and the process information, the RNN-based model to update the weights, wherein the updated weights are stored as non-fungible tokens (NFTs) for use by the RNN-based model for future data transmission requests. For example, and in some embodiments, the system may be configured to train the RNN-based model to update the weight based on the identified parameters to train the model. The parameters may include, but are not limited to, process information, user-selected data carrier information obtained from the data transmission results, and past data transmission results associated with the user.

In some embodiments, the weights may be stored in NFTs 300. Each NFT 300 may represent a unique, verifiable record of the trained weights associated with a specific instance or version of the RNN-based model. The NFTs 300 may be stored on a distributed ledger or distributed ledger-based platform to ensure immutability, traceability, and secure version control of the model's learned parameters. The stored weights in the NFTs 300 may be configured to be shared for another optimal data carrier recommendation process session, either for the same user that previously triggered an update to the weights, or for another user. The weights are updated at the end of such a session and subsequently stored back in the NFTs 300 to reflect recent data transmission activity.

Moreover, the model may be trained using historical labeled data through a gradient-based optimization process, such as backpropagation through time (BPTT), wherein the weights are iteratively adjusted to minimize prediction error. The resulting trained model may be utilized in connection with future data transmission requests initiated by the same user or by other users enrolled to receive optimal data carrier recommendations. This enables the model to generalize learned patterns across multiple users and continuously improve recommendation accuracy over time.

In some embodiments, the optimal data carrier recommendation system is configured to operate in parallel to manage multiple concurrent sessions corresponding to data transmission requests initiated by a plurality of users. Each session is associated with a distinct user context (e.g., user preferences, available data carriers, and the like) and data transmission information. Weight values are retrieved from non-fungible tokens (NFTs) based on the activated neurons and the available data carriers identified for each session. The weight values are updated using session-specific data and subsequently stored back into the NFTs for access and reuse by future sessions. The recommendation processes for individual sessions are executed concurrently to ensure scalability and low-latency response across multiple user interactions.

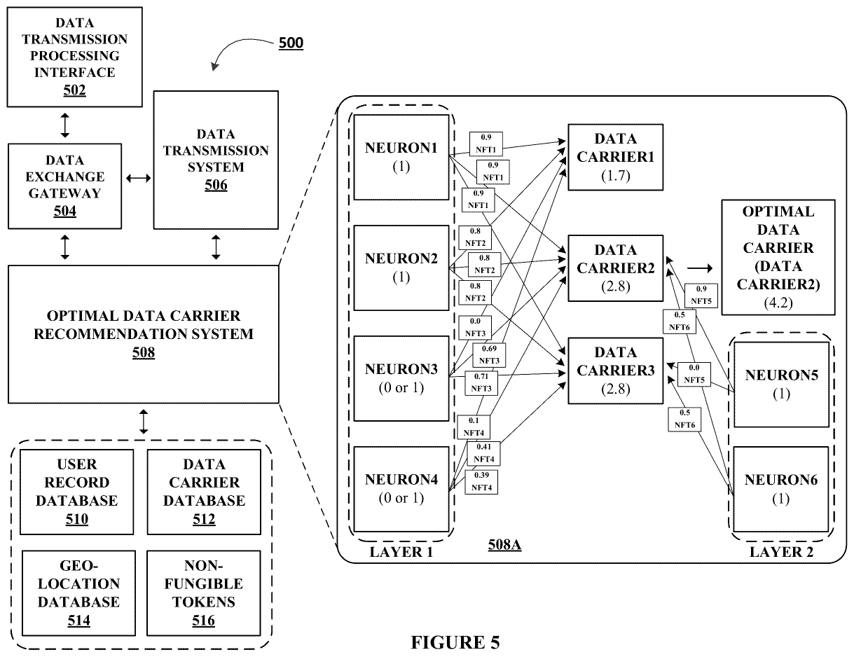

FIG. 5 illustrates an exemplary architecture of the optimal data carrier recommendation system architecture 500, in accordance with an embodiment of the invention. The optimal data carrier recommendation system 500 may include a data transmission processing interface 502, data exchange gateway 504, data transmission system 506, optimal data carrier recommendation system 508, user record database 510, data carrier database 512, geo-location database 514, and non-fungible tokens (NFTs) 516. An exemplary RNN-based recommendation process 508A illustrates the process of the RNN-based model of the optimal data carrier recommendation system 508.

The data transmission processing interface 502 may be an endpoint device 140, such as a point-of-sale (POS) system, an online payment system, a payment platform or application accessed via a user device, a peer-to-peer payment system, and/or similar interfaces. The data transmission processing interface 502 may be configured to transmit a data transmission request, initiated by the user, to the data exchange gateway 504. In some embodiments, the user may interact with the data transmission processing interface 502 to initiate a data transmission, such as making a purchase, executing a peer-to-peer payment, and/or the like. The data transmission processing interface 502 transfers data transmission requests comprising data transmission information, such as amount of data transmission, exchange participant identifier, service category information, user information or information of initially-selected data carrier by the user that comprises user information (e.g., data carrier holder information), geo-location of the data transmission processing interface 502, and/or any other information associated with processing the data transmission. The interface may be further configured to present the optimal data carrier recommendation to the user or, in the case of a point-of-sale (POS) system, to the vendor or operator of the POS terminal. The data transmission processing interface 502 may also be configured to receive user confirmation of the recommendation or an override input selecting an alternative data carrier. Additionally, the data transmission processing interface 502 may collect any contextual data relevant to the data transmission, which may be used to further train or refine the RNN-based model (e.g., geo-location of the data transmission processing interface, data transmission result). The collected data may then be packaged and transmitted to the optimal data carrier recommendation system 508 via the data exchange gateway 504 for training the RNN-based model.

The data exchange gateway 504 may be a middleware component or communication interface configured to facilitate secure and structured data transmission between the data transmission processing interface 502, and the optimal data carrier recommendation system 506. In some embodiments, the data exchange gateway 504 may be responsible for receiving data transmission requests initiated at the data transmission processing interface 502, formatting or encoding a data transmission request into a compatible structure, and routing the request to the appropriate processing modules within the system. The data exchange gateway 504 may also be configured to handle inbound and outbound communications, including receiving optimal data carrier recommendations from the system and transmitting the corresponding results back to the originating data transmission processing interface 502. In certain implementations, the data exchange gateway 504 may support API-based communication protocols, message queuing, encryption, and authentication mechanisms to ensure robust and secure data flow across the distributed computing environment 100.

The data transmission system 506 is a financial entity system architecture configured to support the initiation, processing, and completion of data transmission between users, devices, and service providers. The data transmission system 506 may interact with the data exchange gateway 504 and the optimal data carrier recommendation system 508 to facilitate data transmission request initiated from the user and manage data transmission results.

The optimal data carrier recommendation system 508 is configured to recommend an optimal data carrier to the user upon receiving data transmission request from the data transmission processing interface 502 via the data exchange gateway 504 using the RNN-based model. The optimal data carrier recommendation system 508 is further configured to retrieve input parameters for the RNN-based model from multiple sources, such as the user record database 510, data carrier database 512, geo-location database 514, and NFTs 516. Moreover, the optimal data carrier recommendation system 508 may be further configured to identify parameters for training the RNN-based model, thereby updating the neurons and weights to adaptively adjust the model's processing based on newly observed data or outcomes. For instance, and in some embodiments, the optimal data carrier recommendation system 508 may receive data transmission results from the data exchange gateway 504 following the data transmission, or retrieve the data transmission results from the data transmission system 506. In this way, the optimal data carrier recommendation system 508 may then be configured to identify the actual data carrier used for the data transmission, as well as any other data carriers that were attempted but failed. Additionally, the system may identify network stability conditions or technical issues associated with the data carriers used during the data transmission, based on the geo-location where the data transmission processing interface 502 was located, using geo-location information obtained from the geo-location database 514. Furthermore, the optimal data carrier recommendation system 508 may additionally retrieve training data associated with parameters used by the RNN-based model, such as entitlement information of available data carriers from the data carrier database 512, user feedback information associated with the data transmission, and/or the like.

The user record database 510 may be configured to store the user's enrollment status for receiving optimal data carrier recommendations from the optimal data carrier recommendation system 508 and the user's authorization for the system to execute the optimal data carrier recommendation process. The user record database 510 may further configured to store information about one or more available data carriers for each enrolled and approved user that can be used to execute a data transmission request.

The data carrier database 512 is configured to store entitlement information associated with various data carriers and to provide such entitlement information to the optimal data carrier recommendation system 508. The optimal data carrier recommendation system 508 is configured to access the data carrier database 512 in order to retrieve entitlement information corresponding to the available data carriers identified from the user record database 510. In some embodiments, the data carrier database 512 is configured to update the entitlement information periodically at predefined intervals or dynamically in response to changes or updates in the entitlement terms associated with the data carriers. In some embodiments, the user record database 510 and the data carrier database 512 may be implemented as the same database, or may share information either partially or in full.

The geo-location database 514 may be configured to manage geo-location information and associated network stability condition or technical issue data relevant to data transmission requests exchanged between the data transmission processing interface 502, the data exchange gateway, and the data transmission system 506. In some embodiments, the optimal data carrier recommendation system 508 may be configured to access the geo-location database 514 to retrieve network stability information or technical issue information corresponding to the available data carriers identified from the user record database 510. For instance, the geo-location database 514 may store information indicating data transmission failure rates for specific data carriers within various geo-locations, where such failures may result from network errors, technical issues, and/or the like. The optimal data carrier recommendation system 508 may utilize this information to update the weights by training the RNN-based model, enabling the model to incorporate network stability condition or technical issue as a factor when evaluating and recommending optimal data carriers within the identified geo-location information.

The NFTs 516 may be configured to store trained weight information generated by the optimal data carrier recommendation system 508. In some embodiments, the optimal data carrier recommendation system 508 may be configured to generate NFTs using the process of creating an NFT 300, each representing a unique and immutable instance of trained model parameters, including the weights associated with the neurons of the RNN-based model. The NFTs 516 may be configured to manage metadata associated with each trained weight assigned to each of neurons to the corresponding to data carriers, such as training timestamp, model version, performance metrics, training context, and usage history. By storing trained weights in NFTs, the optimal data carrier recommendation system 508 may facilitate decentralized access, verifiable authenticity, and portable deployment of trained models across different system environments. The stored weights in the NFTs 516 may be configured to be shared for another optimal data carrier recommendation process session, either for the same user who previously triggered an update to the weights, or for another user. The weights may be retrained at the end of such a session and subsequently stored back in the NFTs 516 to reflect recent data transmission activity.

The RNN-based recommendation process 508A illustrates an exemplary computing process for determining the optimal available data carrier by the optimal data carrier recommendation system 508. In this example case, the optimal data carrier recommendation system 508 identifies three available data carriers (e.g., DATA CARRIER1, DATA CARRIER2, and DATA CARRIER3) associated with the user from the user record database 510 to process a data transmission request. The RNN-based model performs a first-layer (e.g., LAYER 1) computation using four neurons (e.g., NEURON1, NEURON2, NEURON3, and NEURON4), with weights assigned to each neuron for each of the identified available data carriers. For example, and in this exemplary case, NEURON1 corresponds to user enrollment status, NEURON2 corresponds to geo-location identification, NEURON3 corresponds to entitlement information, and NEURON4 corresponds to historical data transmission records. A neuron value assigned to each neuron for each corresponding data carrier is either 1 or 0, depending on the status or presence of the respective neuron attribute. The neuron values are multiplied by their corresponding weight values and summed to generate a weighted total. For instance, DATA CARRIER1 is a debit card available to the user. The user is enrolled in the service (NEURON1=1), the geo-location is identified (NEURON2=1), entitlement information is not present (NEURON3=0), and past data transmission records are identified (NEURON4=1). The optimal data carrier recommendation system 508 retrieves corresponding weights for DATA CARRIER1 (e.g., 0.9 for NEURON1, 0.8 for NEURON2, 0 for NEURON3, and 0.1 for NEURON4) and computes the sum of the weighted values, resulting in a total of 1.7. The weights are retrieved from the NFTs 516, which store the latest version of the trained weight values. Similarly, DATA CARRIER2 yields a sum of weighted values of 2.8, and DATA CARRIER3 yields an identical sum of 2.8. The system 506 applies an additional layer (e.g., LAYER 2) of inputs (e.g., NEURON5 and NEURON6) to further distinguish between the data carriers. In this case, NEURON5 corresponds to less data transmission assessments, and NEURON6 corresponds to user feedback response to the data carrier. After incorporating the second-layer computation, the sum of weighted values becomes 4.2 for DATA CARRIER2 and 3.3 for DATA CARRIER3. Accordingly, the system determines that DATA CARRIER2 is the optimal available data carrier, as it has the highest total weighted value. In certain embodiments, the optimal data carrier recommendation system 508 may further convert the sum of weighted values into probability values using, for example, a softmax activation function.

It will be understood that the embodiment of the optimal data carrier recommendation system architecture 500 illustrated in FIG. 5, is exemplary and that other embodiments may vary. As another example, in some embodiments, the optimal data carrier recommendation system 500 may include more, fewer, or different components.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for an optimal data carrier recommendation using a recurrent neural network (RNN) and tokenization, the system comprising:
a network interface configured to communicate via a communication network;
a non-transitory memory device comprising computer-readable program code stored thereon; and
at least one processing device operatively coupled to the network interface and the non-transitory memory device, wherein the computer-readable program code comprises computer instructions configured to, when executed by the at least one processing device, cause the at least one processing device to:
receive, using the network interface and via the communication network, a data transmission request from a data transmission processing interface via a data exchange gateway, wherein the data transmission request is initiated by a user using the data transmission processing interface, wherein the data transmission request comprises data transmission information, and wherein the data exchange gateway facilitates communication with the data transmission processing interface;
identify user information based on the data transmission information;
identify, based on user record information associated with the identified user information, data carriers associated with the identified user information;
identify, based on the identified data carriers and the data transmission information, neurons to be activated in an RNN-based model;
cause the identified neurons to be activated in an RNN-based model;
determine, from the identified data carriers, an optimal data carrier using the RNN-based model, wherein the RNN-based model is configured to (i) compute a sum of weighted values of the activated neurons for each of the identified data carriers based on the activated neurons and corresponding weights assigned to each of the activated neurons for each identified data carrier and (ii) select a data carrier associated with the highest sum of weighted values as the optimal data carrier, and wherein the weights are dynamically updated through training of the RNN-based model;
transfer, using the network interface and via the communication network, data identifying the optimal data carrier to the data transmission processing interface via the data exchange gateway for the optimal data carrier recommendation to the user;
receive, after transferring the data identifying the optimal data carrier, using the network interface and via the communication network, a data transmission result associated with the data transmission request from the data exchange gateway, wherein the data transmission result comprises a user-selected data carrier and process information associated with the data transmission request; and
train, based on the user-selected data carrier and the process information, the RNN-based model to update the weights, wherein the updated weights are stored as non-fungible tokens (NFTs) for use by the RNN-based model for future data transmission requests.

2. The system of claim 1, wherein the RNN-based model is further configured to:
determine, for each activated neuron of the activated neurons, a corresponding priority of the activated neuron;
compute the sum of the weighted values of the activated neurons for each of the identified data carriers based on at least one activated neuron with higher priority to determine the optimal data carrier; and
iteratively compute the sum of the weighted values by adding at least one activated neuron with a next higher priority until only one optimal data carrier with the highest sum of weighted values is determined in an instance where multiple data carriers with identical highest sums are determined.

3. The system of claim 2, wherein the non-transitory memory device comprises computer-readable program code that, when executed by the at least one processing device, causes the at least one processing device to, when training the RNN-based model, update corresponding priorities of the activated neurons in response to changes in the corresponding weights.

4. The system of claim 1, wherein the non-transitory memory device comprises computer-readable program code that, when executed by the at least one processing device, causes the at least one processing device to:
receive, using the network interface via the communication network, and before receiving the data transmission request, an authorization from the user to execute an optimal data carrier recommendation process with the user record information using the user information; and
execute the optimal data carrier recommendation process in response to receiving the data transmission request only in response to receiving the authorization.

5. The system of claim 1, wherein the data transmission processing interface is displayed via a point-of sale device.

6. The system of claim 1, wherein the user record information comprises, for each of a plurality of users, user information identifying one or more data carriers for the user and entitlement information associated with the one or more data carriers.

7. The system of claim 1, wherein the non-transitory memory device comprises computer-readable program code that, when executed by the at least one processing device, causes the at least one processing device to convert the sum of weighted values of the activated neurons for each of the identified data carriers into a probability.

8. The system of claim 1, wherein a first neuron of the identified neurons is identified based on geo-location information of the data transmission processing interface within the data transmission information of the data transmission request, and wherein first weighted values associated with geo-location information assigned to each of the activated neurons for each identified data carrier are updated to reflect network stability condition of a geo-location for data transmission of the data transmission request.

9. The system of claim 1, wherein the updated weights stored as NFTs are used by a first RNN-based model for a first data transmission request from a first user.

10. A computer program product for an optimal data carrier recommendation using a recurrent neural network (RNN) and tokenization, wherein the computer program product comprises at least one non-transitory computer-readable medium having computer-readable program code portion embodied therein, the computer-readable program code portions which when executed by a processing device are configured to cause a processor to:
receive, using the network interface and via the communication network, a data transmission request from a data transmission processing interface via a data exchange gateway, wherein the data transmission request is initiated by a user using the data transmission processing interface, wherein the data transmission request comprises data transmission information, and wherein the data exchange gateway facilitates communication with the data transmission processing interface;
identify user information based on the data transmission information;
identify, based on user record information associated with the identified user information, data carriers associated with the identified user information;
identify, based on the identified data carriers and the data transmission information, neurons to be activated in an RNN-based model;
cause the identified neurons to be activated in an RNN-based model;
determine, from the identified data carriers, an optimal data carrier using the RNN-based model, wherein the RNN-based model is configured to (i) compute a sum of weighted values of the activated neurons for each of the identified data carriers based on the activated neurons and corresponding weights assigned to each of the activated neurons for each identified data carrier and (ii) select a data carrier associated with the highest sum of weighted values as the optimal data carrier, and wherein the weights are dynamically updated through training of the RNN-based model;
transfer, using the network interface and via the communication network, data identifying the optimal data carrier to the data transmission processing interface via the data exchange gateway for the optimal data carrier recommendation to the user;
receive, after transferring the data identifying the optimal data carrier, using the network interface and via the communication network, a data transmission result associated with the data transmission request from the data exchange gateway, wherein the data transmission result comprises a user-selected data carrier and process information associated with the data transmission request; and
train, based on the user-selected data carrier and the process information, the RNN-based model to update the weights, wherein the updated weights are stored as non-fungible tokens (NFTs) for use by the RNN-based model for future data transmission requests.

11. The computer program product of claim 10, wherein the RNN-based model is further configured to:
determine, for each activated neuron of the activated neurons, a corresponding priority of the activated neuron;
compute the sum of the weighted values of the activated neurons for each of the identified data carriers based on at least one activated neuron with higher priority to determine the optimal data carrier; and
iteratively compute the sum of the weighted values by adding at least one activated neuron with a next higher priority until only one optimal data carrier with the highest sum of weighted values is determined in an instance where multiple data carriers with identical highest sums are determined.

12. The computer program product of claim 11, wherein the processing device is further configured to, when training the RNN-based model, update corresponding priorities of the activated neurons in response to changes in the corresponding weights.

13. The computer program product of claim 10, wherein the user record information comprises, for each of a plurality of users, user information identifying one or more data carriers for the user and entitlement information associated with the one or more data carriers.

14. The computer program product of claim 10, wherein a first neuron of the identified neurons is identified based on geo-location information of the data transmission processing interface within the data transmission information of the data transmission request, and wherein first weighted values associated with geo-location information assigned to each of the activated neurons for each identified data carrier are trained to reflect network stability of a geo-location for data transmission of the data transmission request.

15. The computer program product of claim 10, wherein the updated weights stored as NFTs are used by a first RNN-based model for a first data transmission request from a first user.

16. A computer-implemented method for an optimal data carrier recommendation, the method comprising:
receiving, using the network interface and via the communication network, a data transmission request from a data transmission processing interface via a data exchange gateway, wherein the data transmission request is initiated by a user using the data transmission processing interface, wherein the data transmission request comprises data transmission information, and wherein the data exchange gateway facilitates communication with the data transmission processing interface;
identifying user information based on the data transmission information;
identifying, based on user record information associated with the identified user information, data carriers associated with the identified user information;
identifying, based on the identified data carriers and the data transmission information, neurons to be activated in an RNN-based model;
causing the identified neurons to be activated in an RNN-based model;
determining, from the identified data carriers, an optimal data carrier using the RNN-based model, wherein the RNN-based model is configured to (i) compute a sum of weighted values of the activated neurons for each of the identified data carriers based on the activated neurons and corresponding weights assigned to each of the activated neurons for each identified data carrier and (ii) select a data carrier associated with the highest sum of weighted values as the optimal data carrier, and wherein the weights are dynamically updated through training of the RNN-based model;
transferring, using the network interface and via the communication network, data identifying the optimal data carrier to the data transmission processing interface via the data exchange gateway for the optimal data carrier recommendation to the user;
receiving, after transferring the data identifying the optimal data carrier, using the network interface and via the communication network, a data transmission result associated with the data transmission request from the data exchange gateway, wherein the data transmission result comprises a user-selected data carrier and process information associated with the data transmission request; and
training, based on the user-selected data carrier and the process information, the RNN-based model to update the weights, wherein the updated weights are stored as non-fungible tokens (NFTs) for use by the RNN-based model for future data transmission requests.

17. The computer-implemented method of claim 16, wherein the computer-implemented method is further configured for:
determining, for each activated neuron of the activated neurons, a corresponding priority of the activated neuron;
computing the sum of the weighted values of the activated neurons for each of the identified data carriers based on at least one activated neuron with higher priority to determine the optimal data carrier; and
iteratively computing the sum of the weighted values by adding at least one activated neuron with a next higher priority until only one optimal data carrier with the highest sum of weighted values is determined in an instance where multiple data carriers with identical highest sums are determined.

18. The computer-implemented method of claim 17, wherein the processing device is further configured for, when training the RNN-based model, updating corresponding priorities of the activated neurons in response to changes in the corresponding weights.

19. The computer-implemented method of claim 16, wherein a first neuron of the identified neurons is identified based on geo-location information of the data transmission processing interface within the data transmission information of the data transmission request, and wherein first weighted values associated with geo-location information assigned to each of the activated neurons for each identified data carrier are trained to reflect network stability of a geo-location for data transmission of the data transmission request.

20. The computer-implemented method of claim 16, wherein the updated weights stored as NFTs are used by a first RNN-based model for a first data transmission request from a first user.
